(19) United States
(12) Patent Application Publication
(10) Pub. No.: US 2010/0154668 A1
(43) Pub. Date: Jun. 24, 2010

(54) Sheet materials with precise gage pin-accurate elements on front and reverse side

(76) Inventors: Matthias Müller, Fichtenweg (DE); Peter Reich, Schlosspaint (DE); Gottfried Brandstetter, Schiessstatte (AT)

Correspondence Address: WENDEROTH, LIND & PONACK, L.L.P., 1030 15th Street, N.W.,, Suite 400 East, Washington, DC, 20005-1503, US

(21) Appl. No.: 12/656,724

(22) Filed: Feb. 16, 2010

Related U.S. Application Data
(62) Division of application No. 11/394,115, filed on Mar. 31, 2006.

(30) Foreign Application Priority Data
Apr. 13, 2005 (EP) 05 008 032.4-2304

(51) Int. Cl. B41F 33/00

(52) U.S. Cl. 101/483

(57) ABSTRACT

Sheet material with security features disposed on front and reverse side with length and side registration precision, characterized in that a carrier substrate is imprinted with the corresponding features on both sides with gage-pin position accuracy, the tolerance being maximally ±100 μm.

The invention relates to sheet materials with features in precise gage-pin position accuracy on the front and reverse side of the security elements.

Sheet materials employed for security elements with features positioned with gage pin precision on the front and reverse side, are known. Such features may be for example printed letters, figures, symbols and the like.

Such security features are conventionally produced by gage pin-accurate and register-accurate lamination of at least two imprinted carrier substrates.

Such a method is described, for example, in DE A 198 53 444.

However, this method is highly elaborate and expensive. In the known lamination methods, further, the tolerances of the register and gage-pin accuracy are relatively wide, such that the precise gage pin-accurate appearance on the front and reverse side is not ensured. Moreover, in the case of opaque carrier substrates the production of the described security elements by lamination is only possible with difficulties.

The invention addresses the problem of providing a sheet material, which has features located on the front and reverse side in precise length and side registration, in which the utilization of opaque carrier substrates is also possible.

Subject matter of the invention is therefore a sheet material, which has security features on front and reverse side disposed in precise length and side registration, characterized in that a carrier substrate is imprinted with the corresponding features on both sides with gage-pin accuracy, the tolerance being maximally ±100 μm.

The tolerance is preferably up to maximally ±100 μm, especially preferred up to ±50 μm.

Carrier substrates to consider for the security feature according to the invention are possible for example carrier films, preferably flexible synthetic films, of, for example, PI, PP, MOPP, PE, PPS, PEEK, PEK, PEI, PSU, PAEK, LCP, PEN, PBT, PET, PA, PC, COC, POM, ABS, PVC. The carrier films have preferably a thickness of 5-700 μm, preferably 5-200 μm, especially preferred are 5-50 μm.

As the carrier substrate can further also serve metal foils, for example Al, Cu, Sn, Ni, Fe or high-grade steel foils with a thickness of 5-200 μm, preferably 10 to 80 μm, especially preferred are 20-50 μm. The foils can also be surface-treated, coated or laminated, for example with synthetic materials, or lacquered or varnished.

As carrier substrates can further also be utilized paper or composites with paper, for example composites with synthetic materials having a mass per unit area of 20-500 g/m², preferably 40-200 g/m².

Further can be utilized as carrier substrates textiles or nonwovens, such as continuous fiber nonwovens, staple fiber nonwovens, and the like, which may optionally be needled or calendered. Such textiles or nonwovens are preferably comprised of synthetic materials, such as PP, PET, PA, PPS and the like, but textiles or nonwovens of natural, optionally treated, fibers, such as viscose fiber nonwovens can be utilized. The textiles or nonwovens have a mass per unit area of 20 g/m2 to 500 g/m². These textiles or nonwovens can optionally be surface treated.

As the carrier substrate can further also be considered sheet composites, wherein, for example, two identical or different synthetic sheets or sheets of different thickness may be combined with one another. The sheets of these sheet composites can optionally be provided, preferably on the side facing one another, with a functional or decorative layer.

This functional or decorative layer can be, for example, a metallic or a metallically appearing or a reflecting, diffusely scattering layer.

The carrier substrate is now provided on the first side with functional features. These functional features can be, for example, printed figures, letters, symbols, numbers, writings, lines, geometric forms and the like. These features can be applied in positive or negative print. They can be applied as micro- or macrotext or as a combination of micro- and macrotext.

By microtext are understood in this context letters, symbols, figures, lines and sequences thereof having a size of 70-600 μm.

By macrotext is understood in this context letters, symbols, figures, lines and sequences thereof having a size of approximately 600 μm and larger.

The carrier substrate imprinted on one side is subsequently guided over a turning station and imprinted on the second, opposite side with the corresponding features with gage pin and register precision.

Further, front and reverse side can be imprinted according to the method described in AT 412273, wherein imprinting of front to reverse side in precise registration of the substrate proceeds analogously to the method disclosed in AT 412273.

Between two or more registration marks of the material web the register is measured longitudinally via a preceding measuring device and adjusted to the required register length between two or more actuated tensioning assemblies.

Determining the correct register length takes place through inline measuring of the register marks and the correct register length is subsequently adjusted through shrinking by means of a dryer or stretching between two or more tensioning assemblies. By a regulation circuit, in particular a register regulator, the material web is inserted under register control via a register roller preceding the first printing unit, with the side register being driven forward via a web control and/or inserted via a pivoting frame, whereupon the material web is imprinted with gage pin and register precision with respect to the already present coating on the other side of the material web.

Furthermore, corresponding to the number of the desired gage pin- and register-accurate features present on front and reverse side of the carrier substrate, corresponding further security features can be applied or can already be present.

These security features can have, for example, optical, such as for example luminescent (fluorescent or phosphorescent) properties.

These security features can further have electrically conducting and/or magnetic and/or optically active properties.

To produce a feature with electrically conductive properties, for example inks and lacquers can be utilized with electrically conductive pigments, for example graphite, carbon black, conductive organic or inorganic polymers, metal pigments (for example copper, aluminum, silver, gold, iron, chromium and the like), metal alloys such as copper-zinc or copper-aluminum or also amorphous or crystalline ceramic pigments such as ITO, FTO, ATO and the like. Furthermore, doped or non-doped semiconductors such as for example silicon, germanium, gallium arsenide, arsenic or ion conductors such as amorphous or crystalline metal oxides or metal sulfides can also be utilized as additives. To set the electric properties of the layer, further, polar or partially polar compounds such as tensides, or nonpolar compounds such as silicon additives or hygroscopic or nonhygroscopic salts can be utilized or added. Intrinsically conductive organic polymers such as polyaniline, polyacetylene, polyethylene dioxythiophene and/or polystyrene sulfonate can also be added.

To produce an element with magnetic properties, paramagnetic, diamagnetic and also ferromagnetic substances, such as iron, nickel, barium and cobalt or their compounds or salts (for example oxides or sulfides) can be utilized. Especially suitable are Fe(II) and Fe(III) oxides, barium or cobalt ferrites, rare earths and the like.

The optical properties of the layer can be affected by visible inks or pigments, luminescent coloring substances or pigments, which fluoresce or phosphoresce in the visible range, in the UV or the IR range, heat-sensitive inks or pigments, effect pigments, such as liquid crystals, pearlescent, bronze and/or multilayer color change pigments. These can be applied in all possible combinations.

It is also possible to combine different properties by adding various additives listed above. It is for example possible to utilize tinted or dyed and/or conductive magnetic pigments. All said conductive additives are herein utilizable.

Specifically for tinting or dyeing magnetic pigments all known soluble and insoluble coloring substances or pigments can be utilized. For example, a brown magnetic ink can be produced by adding metals which have a metallic, for example silvery, hue.

A layer can further also have optically active properties. In this connection are considered diffraction structures, diffractive structures, holograms, surface reliefs and the like, which optionally may be partially metallized.

These structures are preferably introduced into thermoplastic or UV-curing layers.

Further, it is possible to imprint for example onto an identification feature comprised of the following layers applied on a carrier substrate: in each instance at least one layer reflecting electromagnetic waves, one optically transparent spacer layer and one layer formed of metal clusters, wherein, depending on the angle of viewing, a color change can be observed, onto the visible side of the color change generated through this structure, a feature, for example in the form of letters, figures, symbols, lines, geometric shapes, numbers or the like with a color contrasting with the colors of the color change. On the side proximate to the layer reflecting the electromagnetic waves of the carrier substrate is subsequently also applied a corresponding features, again, in a contrasting color.

Consequently, the first information, for example after a window embedding, for example into a valuable document, a data medium or the like, is clearly detectable on the front side under incident light and detectable on the reverse side via the contrast formation which is entirely within the substrate of the valuable document or of the data medium.

For this purpose the cylinder layout utilized for the impression cylinder is to be formed according to the arrangement of the front and reverse side to be imprinted.

Decisive for the gage-pin marks, which must be applied for the register- and side-accurate gage pin, is the fact of the layout specification in face print, wherein it is necessary to take into consideration that the running direction may be opposite or toward one another. The print image for the reverse side print is structured analogously to the front side printed image.

Both print images are disposed on the cylinder in face print or in face print mirrored about the vertical or horizontal axis. The difference between front and reverse side printing cylinder is determined with the gage pin mark file of the printing program.

The gage-pin mark file for the front side is firmly fixed in the cylinder layout to a position, for example coordinate 0, 0 at a gage-pin mark length x. Before the mounting, the gage-pin marks for the reverse side are vertically mirrored about the horizontal axis. The gage-pin mark length x is subtracted from the cylinder circumference (y) and subsequently the coordinate y, 0 is fixed. This structure of the cylinder layout ensures the longitudinal and lateral print arrangement which is precise with respect to gage pins.

The sheet materials according to the invention can optionally be utilized after they have been cut to size in the form of filaments, bands, strips, patches or other formats as security elements for data media, valuable documents, packagings and the like.

Given appropriate formation of the features, the sheet materials according to the invention can further also be utilized as printed circuit boards, transponders, antennas, circuits, electronic components and the like.

Therein on front and reverse side each are applied electrically conductive structures; the carrier substrate comprised of a flexible synthetic sheet acts as an insulator.

1-9. (canceled)

10. A method for producing a sheet material with security features disposed on a front and a reverse side of the sheet in precise length and side registration, the sheet being imprinted with corresponding features on both sides with gage-pin precision and the tolerance being maximally ±100 μm,
said method comprising disposing a security feature on a front side of a cylinder in face print or in face print mirrored about the vertical or horizontal axis of the cylinder, and fixing gage-pin marks by considering the running direction to the cylinder, and
disposing a security feature on a reverse side of a cylinder in a face print or a face print mirrored about the vertical or horizontal axis of the cylinder, and fixing gage-pin marks by considering the running direction to the cylinder.

11. The method according to claim 10, wherein the disposing of the security feature for the front side of the cylinder is in face print mirrored about the vertical or horizontal axis of the cylinder.

12. The method according to claim 10, wherein the disposing of the security feature for the reverse side of the cylinder is in face print mirrored about the vertical or horizontal axis of the cylinder.

13. The method according to claim 10, wherein the disposing of security feature for the reverse side on the cylinder is in face print mirrored about the vertical or horizontal axis in a straight printing press.

14. The method according to claim 10, wherein the tolerance is maximally ±70 μm.

15. The method according to claim 10, wherein the tolerance is maximally ±50 μm.

16. The method according to claim 10, wherein the security features have optical, electrically conductive and/or magnetic properties.

17. The method according to claim 10, wherein the sheet comprises additional security features imprinted with gage-pin precision on the front side of the cylinder.

18. The method according to claim 10, wherein the sheet comprises additional security features imprinted with gage-pin precision on the reverse side of the cylinder.

19. The method according to claim 10, further comprising depositing one or more functional layers on at least one of the front side and the reverse side of the sheet.

20. The method according to claim 10, wherein a protective lacquer layer and/or an adhesive coating are deposited on at least one of the front side and the reverse side of the sheet.

21. A sheet material comprising security features made by the method of claim 10.
